(19) United States
(12) Patent Application Publication
(10) Pub. No.: US 2022/0383294 A1
(43) Pub. Date: Dec. 1, 2022

(54) METHODS AND SYSTEMS FOR CONDUCTING AN ELECTRONIC COMPETITION

(71) Applicant: Capital One Services, LLC, McLean, VA (US)

(72) Inventor: Alexander MEDEIROS, Arlington, VA (US)

(73) Assignee: Capital One Services, LLC, McLean, VA (US)

(21) Appl. No.: 17/332,232

(22) Filed: May 27, 2021

(51) Int. Cl. G06Q 20/36; G06Q 20/10; G06Q 20/38; G06Q 20/02

(52) U.S. Cl. CPC G06Q 20/363; G06Q 20/108; G06Q 20/389; G06Q 20/02

(57) ABSTRACT

Disclosed are methods, systems, and non-transitory computer-readable medium for conducting an electronic savings competition. A method may include receiving a competition request including at least one goal, generating a competition in which participants each progress toward the at least one goal, and transmitting one or more competition invitations to participate in the competition to one or more user devices associated with one or more users. The method may further include receiving competition invitation acceptances, registering each user as one of the participants in the competition, and monitoring electronic records associated with the participants in the competition for an indication of progress toward the at least one goal. In response to detecting an indication of progress toward the at least one goal or an indication of completion of the goal, the method may include evaluating standings and determining a winner of the competition.

### TECHNICAL FIELD

Various embodiments of the present disclosure relate generally to methods and systems for conducting an electronic competition and, more particularly, to methods and systems for generating a savings competition and monitoring electronic records to determine participant progress.

### BACKGROUND

While it is certainly important to develop good financial habits, it can be difficult to motivate oneself to do so. For example, saving is a habit that many would like to nurture, but also one that someone may not feel sufficient motivation or emotional reward to actually practice. Strategies for motivating and incentivizing positive behaviors, such as those associated with improved health or financial outcomes, can include positive or negative reinforcement, feedback, accountability to others, and competition to name a few. In order to apply these strategies to a particular habit, systems and methods are needed to provide the necessary structure and environment to enable someone to work on the chosen habit.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, methods and systems are disclosed for conducting an electronic competition including monitoring electronic records to determine participant progress. The methods and systems may create a competition based on real-world interactions (e.g., interactions that have some connection to resources that exist outside the context of the competition itself), monitor electronic records to determine participant progress, and provide notifications of progress and competition completion to users.

For instance, a method may include receiving a competition request including at least one goal corresponding to real-world participant interaction behavior, generating a competition in which two or more participants each progress toward the at least one goal, and transmitting one or more competition invitations to participate in the competition to one or more user devices associated with one or more users. The method may further include receiving one or more competition invitation acceptances, registering each user corresponding to each of the one or more competition invitation acceptances as one of the two or more participants in the competition, and monitoring electronic records associated with the two or more participants in the competition for an indication of progress toward the at least one goal. In response to detecting an indication of progress toward the at least one goal, the method may include evaluating standings of the two or more participants based on the detected indication of progress toward the at least one goal, and publishing a message including the standings of the two or more participants to one or more user devices associated with the two or more participants. Further, in response to detecting a first indication of completion of the at least one goal by one of the two or more participants, the method may include determining one of the two or more participants to be a winner of the competition, and publishing, to one or more user devices associated with the two or more participants, a message including an identification of the winner of the competition.

A system may include a memory storing instructions and a processor executing the instructions to perform a process. The process may include receiving a competition request including at least one goal corresponding to real-world participant interaction behavior, generating a competition in which two or more participants each progress toward the at least one goal, and transmitting one or more competition invitations to participate in the competition to one or more user devices associated with one or more users. The process may further include receiving one or more competition invitation acceptances, registering each user corresponding to each of the one or more competition invitation acceptances as one of the two or more participants in the competition, and monitoring electronic records associated with the two or more participants in the competition for an indication of progress toward the at least one goal. In response to detecting an indication of progress toward the at least one goal, the process may include evaluating standings of the two or more participants based on the detected indication of progress toward the at least one goal, and publishing a message including the standings of the two or more participants to one or more user devices associated with the two or more participants. Further, in response to detecting a first indication of completion of the at least one goal by one of the two or more participants, the process may include determining one of the two or more participants to be a winner of the competition, and publishing, to one or more user devices associated with the two or more participants, a message including an identification of the winner of the competition.

A non-transitory computer-readable medium may store instructions that, when executed by a processor, cause the processor to perform a method. The method may include: receiving a competition request including at least one savings goal corresponding to real-world participant interaction behavior, generating a competition in which two or more participants each progress toward the at least one savings goal, and transmitting one or more competition invitations to participate in the competition to one or more user devices associated with one or more users. The method may further include receiving one or more competition invitation acceptances each including permission to access interaction records for an existing account and/or a request to generate an account for which the interaction records will be accessed during the competition, registering each user corresponding to each of the one or more competition invitation acceptances as one of the two or more participants in the competition, and monitoring electronic records associated with the two or more participants in the competition for an indication of progress toward the at least one goal. In response to detecting an indication of progress toward the at least one goal, the method may include evaluating standings of the two or more participants based on the detected indication of progress toward the at least one goal, and publishing a message including the standings of the two or more participants to one or more user devices associated with the two or more participants. Further, in response to detecting a first indication of completion of the at least one goal by one of the two or more participants, the method may include determining one of the two or more participants to be a winner of the competition, and publishing, to one or more user devices associated with the two or more participants, a message including an identification of the winner of the competition.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system environment for conducting an electronic competition, according to one or more embodiments.

FIG. 2 depicts a flowchart of an exemplary method of conducting an electronic competition, according to one or more embodiments.

FIGS. 3A-3C depict exemplary user interfaces that may provide prompts to a user on a user device, according to one or more embodiments.

FIG. 4 depicts an example system that may execute techniques presented herein.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In general, the present disclosure is directed to methods and systems for conducting an electronic competition based on real-world interactions (e.g., interactions that have some connection to resources that exist outside the context of the competition itself). In particular, a system of the present disclosure may receive a competition request, for example, from a person looking to improve their financial habits. The request may be for a savings competition with a certain savings amount or percentage as the goal, or it may allow the participants to choose their own goals. In some cases, the request may identify at least one other person to whom invitations to the competition may be sent, and additional invitees may be designated later, for example by one or more of the participants. After invitations to the competition are sent, acceptances can come back from the invitees. The invitation acceptances can include, for example and not limitation, credentials to access electronic bank records or a request to open a new savings account. Once the competition starts, the participants can make contributions towards their goals, and the electronic bank transaction records can be monitored for progress. There may be a portal or user interface that the participants can use to follow the participants' progress, and there may also be notifications (such as push notifications from a mobile or web-based application, SMS messages, and/or emails), to notify participants of progress and/or goal completion. Once the competition has ended and a winner has been determined, the participants can be notified of the end of the competition, and if desired, to initiate a subsequent or rematch competition. A combination of one or more of the feedback provided by regular updates, the accountability of knowing other participants may know if good habits aren't being exercised, the desire to win the competition, and the possible reward for doing so can be a powerful tool to create, modify, or reinforce good financial habits.

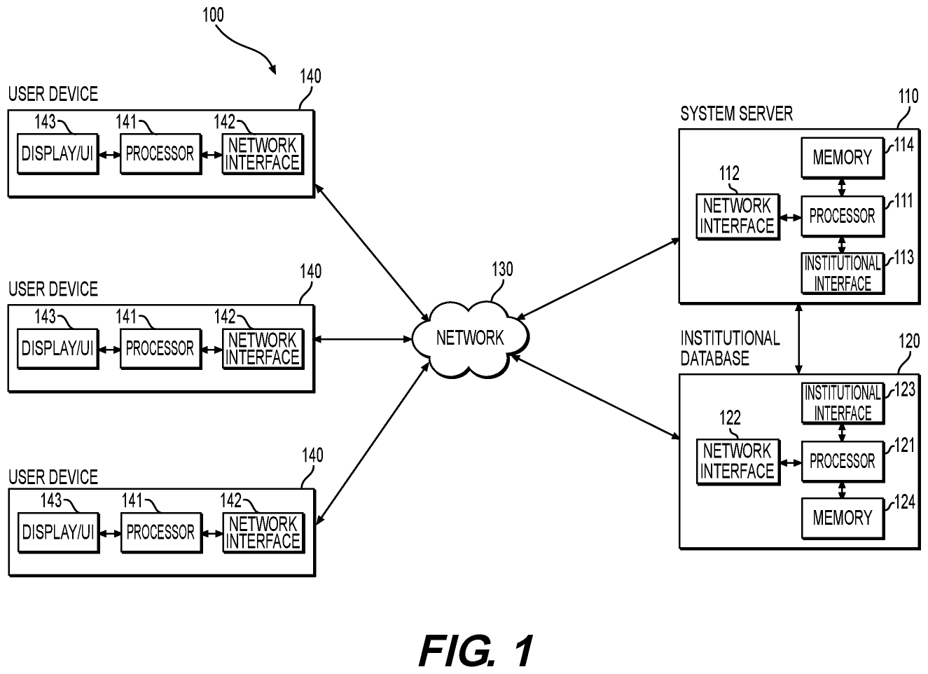

FIG. 1 depicts an exemplary block diagram of a system environment 100 according to one or more embodiments of the present disclosure. For example, the environment 100 may include system server 110 which may generate the competition and monitor electronic records during the competition. System server 110 may include a processor 111 to execute instructions, and a network interface 112 with which to communicate with other elements in system environment 100. System server 110 may also include an institutional interface 113, in addition to or in combination with network interface 112, which may enable system server 110 to communicate with a secure institutional database 120. Instructions to be executed by processor 111 may be stored in memory 114.

Institutional database 120 may be, for example, a secure server or other system associated with an institution and on which interaction data may be stored. Institutional database 120 may include a processor 121 that may execute instructions stored in a memory 124 in order to allow institutional database 120 to receive and store interaction data received via a network interface 122 and/or an institutional interface 123.

Network interface 112 of system server 110 and network interface 122 of institutional database 120 may communicate with each other and/or other elements of the system environment 100 via network 130. Network 130 may be implemented as, for example, the Internet, a wireless network, a wired network (e.g., Ethernet), a local area network (LAN), a Wide Area Network (WANs), Bluetooth, Near Field Communication (NFC), or any other type of network or combination of networks that provides communications between one or more components of the system environment 100. In some embodiments, the network 130 may be implemented using a suitable communication protocol or combination of protocols such as a wired or wireless Internet connection in combination with a cellular data network.

Network 130 may provide system server 110 and institutional database 120 with a connection to one or more user devices 140. User devices 140 can be, for example, a computer, telephone, tablet, or other device that can allow a person to participate in an electronic competition, such as a savings competition. Each user device 140 may include a processor 141, a network interface 142, and a display/user interface (UI) 143.

Display/UI 143 can be in communication with processor 141 to provide the user or users of the device with competition-related information and to allow users to provide inputs to the system server 110 in order to control, modify, and/or monitor participation in the competition. In some embodiments in accordance with the present disclosure, display/UI 143 may include one or more monitors, touchscreen panels, keyboards, keypads, mice/trackpads, and/or other suitable devices for displaying information to, or for receiving inputs from, users of user device 140. User device 140 may be capable of allowing a user to, for example and not limitation, receive user input via display/UI 143 and transmit a competition request, provide an acceptance to a competition invitation, and receive a message including the standings and/or winner of the competition and display the message to a user via display/UI 143.

While system environment 100, as illustrated in FIG. 1, is depicted as having three user devices 140, this disclosure contemplates that there may be more of these (or other) elements without departing from the scope of the disclosure. For example, each participant may be associated with a particular user device 140, multiple user devices 140, or may share a user device 140 with other participants by having a unique account and/or log in information that allows the system server 110 to understand which user is accessing the user device 140 at a given time.

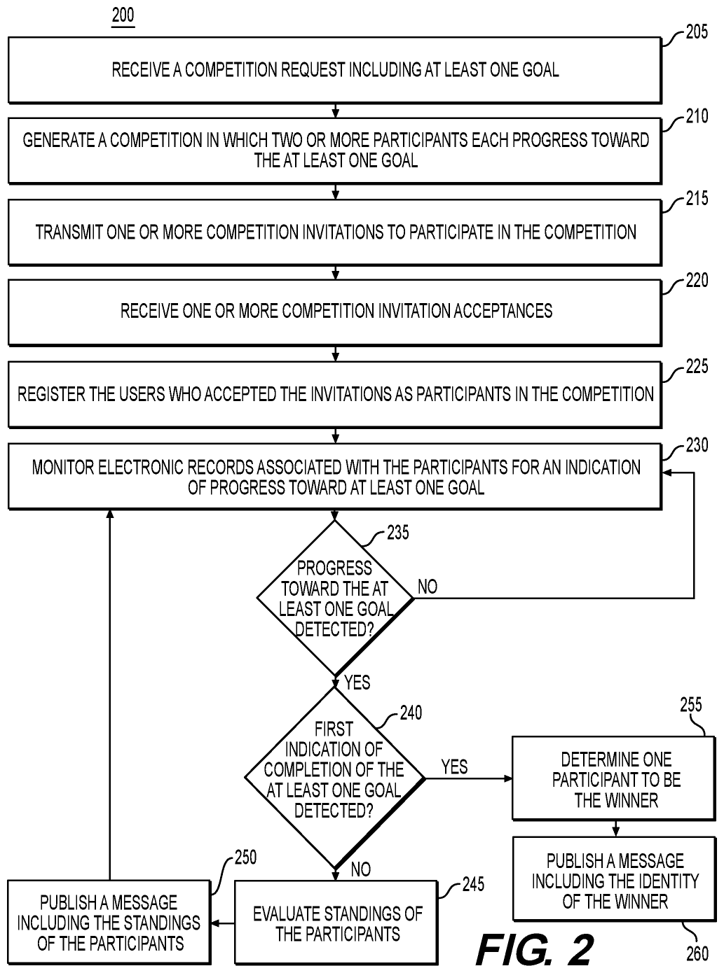

FIG. 2 depicts a flowchart illustrating a method 200 for conducting an electronic savings competition, according to one or more embodiments of the present disclosure. The method may be performed by a system in accordance with the present disclosure, including one or more of the devices that comprise the system environment 100.

Method 200 may begin at step 205 with the receipt of a competition request including at least one goal by, for example, system server 110. The competition request may be sent via, for example, one or more user devices 140. The competition request may include, for example, a desired competition start and/or end date, duration, goal, list of participants, competition rewards (e.g., coupons, donations, credits, etc.), or any other parameter relevant to the creation and administration of the desired competition.

Once the competition request is received, system server 110 can process the request at step 210 to generate a competition. The competition may be structured such that two or more participants will each progress toward the at least one goal. In some embodiments in accordance with the present disclosure, each participant may have their own individual goal or they may share a common goal. Goals may take different forms capable of being electronically monitored such as, for example and not limitation, saving a certain amount of money in a designated account, saving towards paying off a bill, limiting spending in a particular category (e.g., fast food, shopping) to a designated amount, or other such goal designed to encourage a desired behavior. The goal(s) selected can correspond to real-world interactions, and in particular, those capable of being monitored via electronic records.

Having generated the competition, at step 215, system server 110 may transmit one or more invitations to participate in the competition. These invitations may be sent to a list of invitees (e.g., via email, text message, message through mobile application) provided with the initial competition request, and/or may be sent to invitees identified by other participants. The invitees may each be able to view the invitations on one or more user devices 140, and may also be able to provide responses via display/UI 143.

For example, invitations may notify invitees of the starting and/or ending dates/times for the competition as well as the goal to be met and any prize associated with winning the competition. In some embodiments, the invitation may include options for the invitee to select or adjust their own goal prior to accepting the invitation. Invitations may also include requests for permission and/or logistical or other information that would enable system server 110 to conduct the competition and monitor electronic records associated with one or more existing accounts designated by the invitee. Invitations may also include an option for the invitee to request that an account be created on their behalf. These accounts may be temporary accounts, to be automatically closed at the end of the competition, or permanent accounts, to remain open after the competition ends.

As the invitees provide responses to the invitations to the competition, at step 220, one or more invitation acceptances can be received by system server 110. In response to the invitation acceptances received, at step 225, system server 110 may register those invitees who accepted their invitations as participants in the competition. Depending on the competition, goal, account types, requests for account creation, or other competition and invitation response parameters, the registration process may require information to be gathered from participants, institutional database 120, or another source. Information to be gathered may include, for example, a participant's name, contact information, and account credentials for accessing and/or reading electronic records. System server 110 may determine whether or not additional information is needed, and further, what source is most likely to include the necessary information. Once system server 110 has collected the necessary information, each participant can be registered and system server 110 will be able to access the account or accounts needed to initiate the competition.

At a designated time, the competition will begin, and at step 230, system server 110 may use the access granted and/or the records associated with the newly created accounts to monitor the participant's progress toward the at least one goal. Participant progress may be monitored periodically at fixed intervals, or may be monitored in response to a triggering event, such as a participant conducting an action in an app or web portal, such as requesting competition standings, or updating their progress toward the goal.

While monitoring the electronic records, at step 235, the system server 110 may query whether or not there has been any progress toward the goal. For example, this may be done by comparing a current electronic record to a previously monitored electronic record, or by searching for interactions that are more recent than the last known monitoring time. For example, interactions may be deposits of resources into a monitored account, interactions that result in resources being moved out of a monitored account, or other such interactions that bear on the participant's progress toward the goal.

If no progress has been detected (step 235: No), the method may return to step 230 and continue to monitor the electronic records. Finding that no progress has been made may cause the system server 110 to wait for a particular period of time before re-attempting to monitor participant's accounts, or it may cause system server 110 to continue to follow its periodic monitoring. However, when progress is detected (step 235: Yes), the next inquiry at step 240 can be whether or not the progress detected includes one of the participants having reached their goal. Depending on the structure of a particular competition, a participant reaching their goal may cause the competition to end, or it may allow the remaining participants to compete for second place. In some embodiments, the competition will not end until a particular number of participants have reached their goal, or until a specified date.

Provided none of the participants have reached their goal (step 240: No), the method can proceed to step 245 and evaluate the standings of the competition participants. Standings may be determined based on parameters such as amount of resources saved/spent, percentage of resources saved/spent, number or frequency of interactions, or another suitable parameter that pertains to the participants' goal(s). The standings may take the form of a list of the participants in order of their proximity to the goal, amount saved, or other relevant ranking criteria. In some embodiments, the standings may be a full or partial ranking of the participants. At step 250, system server 110 may publish a message that includes the standings of the participants, and that is accessible to participants on user devices 140. Participants may receive periodic standings updates, and/or updates may be available upon request.

When one of the participants has reached their goal (step 240: Yes), the method can proceed to step 255 and determine the winner of the competition. In some forms of competition in accordance with the present disclosure, the competition may end upon a participant reaching their goal, while other forms of competition may continue until a predetermined time and date, with the winner being determined by the amount of progress achieved in that time period. At step 260, system server 110 may publish a message that identifies the winner of the competition. The message may further include the relative standings of other participants, and/or may indicate other participant placement (e.g., second place, third place, etc.). Upon completion of the competition, system server 110 may offer the participants an opportunity to rematch or otherwise initiate another competition.

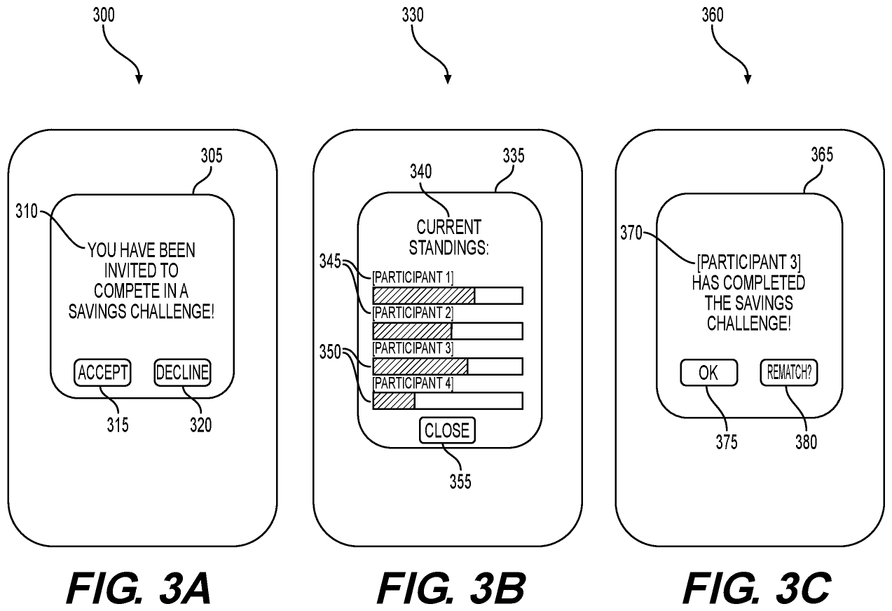

FIGS. 3A-3C illustrate exemplary graphical user interfaces (GUIs) 300, 330, 360 that may be displayed on user devices 140. GUIs 300, 330, 360 may, for example, represent the user interfaces used to invite, display standings, and declare a winner to the competition.

GUI 300 may represent an exemplary user interface that a user may see when they have been invited to join a competition, in accordance with the disclosure. Element 305 may indicate the message that may be displayed on user device 140 when they are invited to join a competition, and element 310 may indicate the message text that notifies the user of their invitation. Element 315 may be a button or other graphical element that the user may interact with to accept the invitation, while element 320 may be a button or other graphical element that the user may interact with to decline the invitation. Upon declining an invitation, the GUI 300 may be cleared from the display 143 of user device 140, while upon acceptance of an invitation, GUI 300 may advance to subsequent screens to collect additional information from the participant as discussed above.

Once the user has accepted and the competition has begun, GUI 330 may represent an exemplary user interface that a participant may see during the competition and wish to check the standings of the other participants in the competition. Element 335 may indicate the message that may be displayed on user device 140 when they are viewing the leader board during the competition. Element 340 may indicate the message text that notifies the user that they are viewing the current standings of the participants in the competition, with the participants listed as elements 345, and the progress of those participants indicated, for example and not limitation, as progress bars displayed as elements 350. The manner in which progress and standings may be displayed may vary based on factors such as the type of competition, the particular goal for the competition, and/or participant preferences. Element 355 may be a button or other graphical element that the user may interact with to exit the current standings view.

GUI 360 may represent an exemplary user interface that a user may see when the competition has ended, and a winner has been declared. Element 365 may indicate the message that may be displayed on user device 140 when the winner of the competition has been declared, and element 370 may indicate the message text that notifies the participant of the declared winner. In some embodiments, there may only be one winner, while other embodiments may have multiple winners identified, and/or other placements (e.g., second place, third place, etc.). Element 375 may be a button or other graphical element that the user may interact with to indicate that they have viewed the message (and selection thereof may close or otherwise exit the current view), and element 380 may be a button or other graphical element that the user may interact with to submit a request for a rematch or additional competition.

A system in accordance with the present disclosure, in executing the method 200 as discussed above, may provide participants with a competition that may motivate the participants to nurture good financial habits. The system server 110 may automatically create and/or access participant accounts, monitor electronic records, determine the standings of the participants, and provide notifications (e.g., participant standings, winners) to the participants. This may result in the participants being encouraged to nurture and develop the desired financial habits and/or awareness.

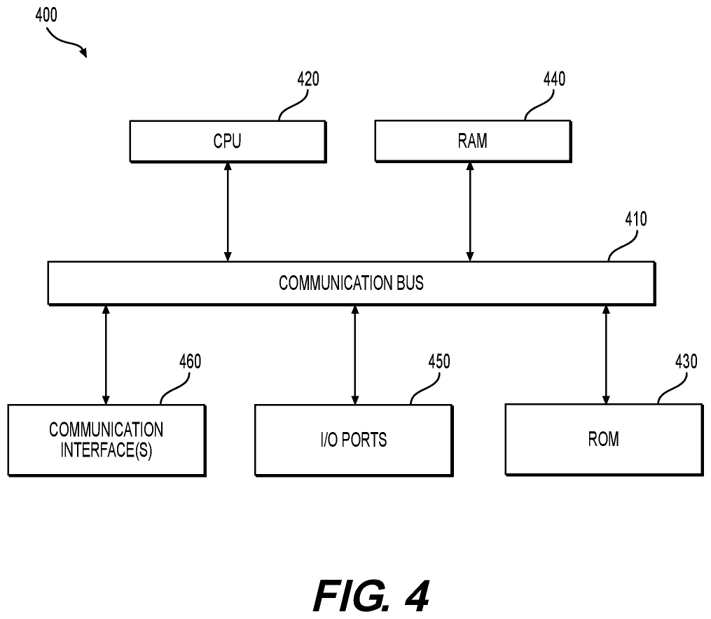

FIG. 4 depicts an example system that may execute techniques presented herein. FIG. 4 is a simplified functional block diagram of a computer that may be configured to execute techniques described herein, according to exemplary embodiments of the present disclosure. Specifically, the computer (or “platform” as it may not be a single physical computer infrastructure) may include a data communication interface 460 for packet data communication. The platform may also include a central processing unit (CPU) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of conducting an electronic competition based on real-world interactions, the method comprising:
receiving a competition request including at least one goal, wherein the at least one goal corresponds to real-world participant interaction behavior that is capable of being monitored via electronic records;
generating, in response to the competition request, a competition in which two or more participants each progress toward the at least one goal;
transmitting, to one or more user devices associated with one or more users, one or more competition invitations to participate in the competition;
receiving, from the one or more user devices associated with the one or more users, one or more competition invitation acceptances;
in response to receiving each of the one or more competition invitation acceptances, registering a corresponding user as one of the two or more participants in the competition;
monitoring electronic records associated with the two or more participants in the competition for an indication of progress toward the at least one goal; and
in response to detecting an indication of progress toward the at least one goal:
evaluating standings of the two or more participants based on the detected indication of progress toward the at least one goal; and
publishing, to one or more user devices associated with the two or more participants, a message including the standings of the two or more participants;
in response to detecting a first indication of completion of the at least one goal by one of the two or more participants:
determining one of the two or more participants to be a winner of the competition; and
publishing, to the one or more user devices associated with the two or more participants, a message including an identification of the winner of the competition.

2. The method of claim 1, wherein the at least one goal is received from one of the one or more user devices associated with the two or more participants.

3. The method of claim 1, wherein the at least one goal relates to saving resources.

4. The method of claim 3, wherein saving resources comprises moving resources into an account designated for savings.

5. The method of claim 1, wherein the one or more competition invitation acceptances each include at least one of:
permission to access interaction records for an existing account; and
a request to generate an account for which the interaction records will be accessed during the competition.

6. The method of claim 5, further comprising, in response to receiving a request to generate an account:
generating an account; and
transmitting, to the participant corresponding to the request to generate an account, information relating to the account.

7. The method of claim 5, wherein permission to access interaction records for an existing account includes one or more credentials that enable access to the existing account.

8. The method of claim 1, wherein monitoring electronic records associated with the participants in the competition for an indication of progress toward the at least one goal includes accessing interaction records associated with participants and comparing current interaction records with previous interaction records.

9. The method of claim 8, wherein the indication of progress toward the at least one goal includes current interaction records that reflect the participant being closer to the at least one goal than the previous interaction records.

10. The method of claim 1, wherein evaluating the standings of the participants includes:
determining the progress for each of the two or more participants; and
ranking the two or more participants based on how close each of the two or more participants is to the at least one goal.

11. A system comprising:
a memory storing instructions; and
a processor executing the instructions to perform a process including:
receiving a competition request including at least one goal, wherein the at least one goal corresponds to real-world participant interaction behavior that is capable of being monitored via electronic records;
generating, in response to the competition request, a competition in which two or more participants each progress toward the at least one goal;
transmitting, to one or more user devices associated with one or more users, one or more competition invitations to participate in the competition;
receiving, from the one or more user devices associated with the one or more users, one or more competition invitation acceptances;
in response to receiving each of the one or more competition invitation acceptances, registering a corresponding user as one of the two or more participants in the competition;
monitoring electronic records associated with the two or more participants in the competition for an indication of progress toward the at least one goal; and
in response to detecting an indication of progress toward the at least one goal:
evaluating standings of the two or more participants based on the detected indication of progress toward the at least one goal; and
publishing, to one or more user devices associated with the two or more participants, a message including the standings of the two or more participants;
in response to detecting a first indication of completion of the at least one goal by one of the two or more participants:
determining one of the two or more participants to be a winner of the competition; and
publishing, to the one or more user devices associated with the two or more participants, a message including an identification of the winner of the competition.

12. The system of claim 11, wherein the at least one goal is received from one of the one or more user devices associated with the two or more participants.

13. The system of claim 11, wherein the at least one goal relates to saving resources.

14. The system of claim 13, wherein saving resources comprises moving resources into an account designated for savings.

15. The system of claim 11, wherein the one or more competition invitation acceptances each include at least one of:
permission to access interaction records for an existing account; and
a request to generate an account for which the interaction records will be accessed during the competition.

16. The system of claim 15, further comprising, in response to receiving a request to generate an account:
generating an account; and
transmitting, to the participant corresponding to the request to generate an account, information relating to the account.

17. The system of claim 15, wherein permission to access interaction records for an existing account includes one or more credentials that enable access to the existing account.

18. The system of claim 11, wherein monitoring electronic records associated with the participants in the competition for an indication of progress toward the at least one goal includes accessing interaction records associated with participants and comparing current interaction records with previous interaction records.

19. The system of claim 11, wherein evaluating the standings of the participants includes:
determining the progress for each of the two or more participants; and
ranking the two or more participants based on how close each of the two or more participants is to the at least one goal.

20. A non-transitory computer-readable medium storing instructions that, when executed by a processor, cause the processor to perform a method, the method comprising:
receiving a competition request including at least one savings goal, wherein the at least one savings goal corresponds to real-world participant interaction behavior that is capable of being monitored via electronic records;
generating, in response to the competition request, a competition in which two or more participants each progress toward the at least one savings goal;
transmitting, to one or more user devices associated with one or more users, one or more competition invitations to participate in the competition;
receiving, from the one or more user devices associated with the one or more users, one or more competition invitation acceptances,
wherein the one or more competition invitation acceptances each include at least one of:
permission to access interaction records for an existing account; and
a request to generate an account for which the interaction records will be accessed during the competition;
in response to receiving each of the one or more competition invitation acceptances, registering a corresponding user as one of the two or more participants in the competition;
monitoring electronic records associated with the two or more participants in the competition for an indication of progress toward the at least one savings goal;
in response to detecting an indication of progress toward the at least one savings goal:
evaluating standings of the two or more participants based on the detected indication of progress toward the at least one goal; and
publishing, to one or more user devices associated with the two or more participants, a message including the standings of the two or more participants;
in response to detecting a first indication of completion of the at least one savings goal by one of the two or more participants:
determining one of the two or more participants to be a winner of the competition; and
publishing, to the one or more user devices associated with the two or more participants, a message including an identification of the winner of the competition.
